(19) United States
(12) Patent Application Publication
(10) Pub. No.: US 2014/0067852 A1
(43) Pub. Date: Mar. 6, 2014

(54) MECHANISM FOR FACILITATING SCALING AND EFFICIENT MANAGEMENT OF DATABASE SYSTEMS AND RESOURCES IN AN ON-DEMAND SERVICES ENVIRONMENT

(71) Applicant: SALESFORCE.COM,INC., San Francisco, CA (US)

(72) Inventors: DANIEL WONG, Palo Alto, CA (US); PUNIT JAIN, Cupertino, CA (US); YANIK GRIGNON GRIGNON, Newton, MA (US)

(73) Assignee: SALESFORCE.COM,INC., SAN FRANCISCO, CA (US)

(21) Appl. No.: 13/841,350

(22) Filed: Mar. 15, 2013

Related U.S. Application Data
(60) Provisional application No. 61/697,499, filed on Sep. 6, 2012.

(51) Int. Cl. G06F 17/30

(52) U.S. Cl. CPC G06F 17/30424
USPC 707/769

(57) ABSTRACT

In accordance with embodiments, there are provided mechanisms and methods for facilitating efficient management of database systems and resources in an on-demand services environment in a multi-tenant environment according to one embodiment. In one embodiment and by way of example, a method includes receiving a job request from a user associated with an organization, where the job request may is placed at a computing device. The method may further include generating, at the local database coupled with the computing device, a dynamic cache having a first table comprising external data from an external data source, communicating the first table of the dynamic cache with a second table at the local database, where the second table comprises local data from the local database, and processing the job request at the local database using the dynamic cache.

### CLAIM OF PRIORITY

This application claims the benefit of U.S. Provisional Patent Application No. 61/697,499, entitled “Method for Scaling an On-Demand System” by Daniel Wong, et al., filed Sep. 6, 2012 (Attorney Docket No.: 8956P113Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating efficient management of database systems and resources in an on-demand services environment.

### BACKGROUND

In traditional on-demand environments, middle-tier systems are imposed between application servers and user equipment and, in conventional systems, backend transaction repositories are often used for large amounts of data processing. However, these backend repositories are inflexible not scalable and therefore often become the choking point in the architecture as they cannot be extended to the middle-tier. Further, this inflexibility and lack of scalability results in expensive overhead and inefficient data processing.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a dynamic cache management mechanism according to one embodiment;

FIG. 2 illustrates a dynamic cache management mechanism according to one embodiment;

FIG. 3 illustrates an architecture having a dynamic cache as facilitated by a dynamic cache management mechanism according to one embodiment;

FIG. 4 illustrates a method for facilitating scaling and efficient management of database systems and resources in an on-demand services environment in a multi-tenant environment according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### SUMMARY

In accordance with embodiments, there are provided mechanisms and methods for facilitating efficient management of database systems and resources in an on-demand services environment in a multi-tenant environment according to one embodiment. In one embodiment and by way of example, a method includes receiving a job request from a user associated with an organization, where the job request may is placed at a computing device. The method may further include generating, at the local database coupled with the computing device, a dynamic cache having a first table comprising external data from an external data source, communicating the first table of the dynamic cache with a second table at the local database, where the second table comprises local data from the local database, and processing the job request at the local database using the dynamic cache.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### DETAILED DESCRIPTION

Methods and systems are provided for facilitating efficient management of database systems and resources in an on-demand services environment in an on-demand services environment. In one embodiment and by way of example, a method includes receiving a job request from a user associated with an organization, where the job request may is placed at a computing device. The method may further include generating, at the local database coupled with the computing device, a dynamic cache having a first table comprising external data from an external data source, communicating the first table of the dynamic cache with a second table at the local database, where the second table comprises local data from the local database, and processing the job request at the local database using the dynamic cache.

Embodiments provide for facilitating a scalable and distributive on-demand system to offer smooth, efficient, and dynamic communication between various tiers of a multi-tiered, multi-tenant, server-client architecture. For example, in one embodiment, in a multi-tiered server-client system, a dynamic cache may be employed at a one of the tiers of the multi-tiered system such that, for example, any data processing that is typically performed at a backend transaction repository or an external data processing server/system (e.g., Apache™ HBase™, Apache™ Hadoop®, a Structured Query Language (SQL)-based relational database management system (RDBMS), etc.) may be performed at data service to provide fast and efficient results for user queries (e.g., SQL queries), requests, jobs, etc. Having a dynamic cache allows for better scalability and more efficiency by providing processing space at a local multi-tenant database such that any tasks (e.g., job requests) may be locally-processed at the local database, via the dynamic cache, without having to rely on the remotely-located, inflexible, and resource-consuming data processing server.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

Next, mechanisms and methods for facilitating a mechanism for facilitating scaling and efficient management of database systems and resources in an on-demand services environment in a multi-tenant environment in an on-demand services environment will be described with reference to example embodiments.

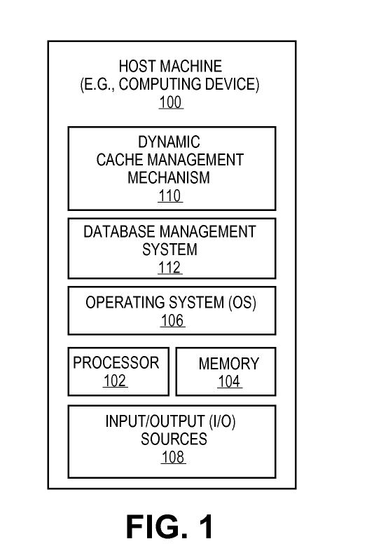

FIG. 1 illustrates a computing device 100 employing dynamic cache management mechanism 110 according to one embodiment. In one embodiment, computing device 100 serves as a host machine employing dynamic cache management mechanism (“cache mechanism”) 110 for facilitating a scalable and distributive on-demand system to offer smooth, efficient, and dynamic communication between various tiers of a multi-tiered, multi-tenant, server-client architecture for providing better management of system resources as well as promoting customization of various services typically desired or necessitated by a user or a representative of an organization/client, such as a company, a corporation, a non-profit organization, a business, an agency, an institution, etc. The user refers to a customer/client of a service provider (e.g., Salesforce.com®) that provides and manages adjustment mechanism 110 at a host machine, such as computing device 100. It is to be noted that terms like “user”, “customer”, “organization”, “tenant”, “business”, “company”, etc., may be used interchangeably throughout this document.

Computing device 100 may include server computers (e.g., cloud server computers, etc.), desktop computers, cluster-based computers, set-top boxes (e.g., Internet-based cable television set-top boxes, etc.), and the like. Computing device 100 may also include smaller computers, such as mobile computing devices, such as cellular phones including smartphones (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles®, etc.), Global Positioning System (GPS)-based navigation systems, etc.

Computing device 100 includes an operating system (OS) 106 serving as an interface between any hardware or physical resources of the computing device 100 and a user. Computing device 100 further includes one or more processors 102, memory devices 104, database management system 112, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “client”, “client device”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “application”, “software application”, “program”, “software program”, “package”, and “software package” may be used interchangeably throughout this document. Moreover, terms like “job”, “request” and “message” may be used interchangeably throughout this document.

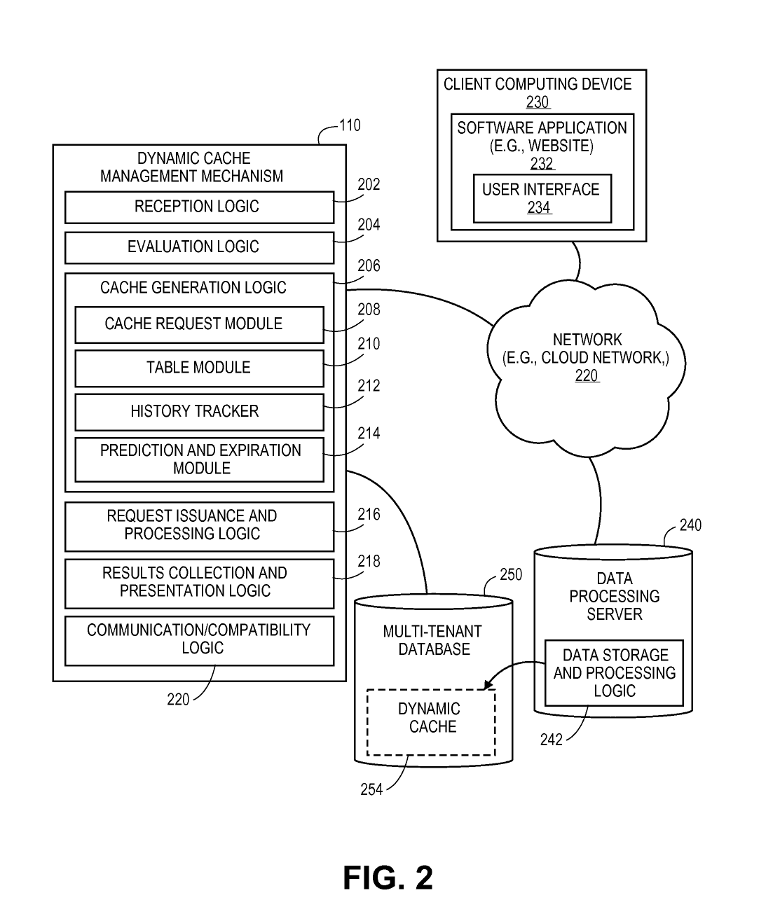

FIG. 2 illustrates dynamic cache management mechanism 110 according to one embodiment. In one embodiment, cache mechanism 110 includes a number of components, such as reception logic 202, evaluation logic 204, cache generation logic 206 including cache request module 208, table module 210, history tracker 212, prediction module 214, request issuance and processing logic 216, results collection and presentation logic 218, and communication/compatibility logic 220. Throughout this document, “logic” may be interchangeably referred to as “component” or “module” and may include, by way of example, software, hardware, and/or any combination of software and hardware, such as firmware.

In one embodiment, cache mechanism 110 may be employed at a server computing system, such as computing device 100 of FIG. 1, and may be in communication with one or more client computing devices, such as client computing device 230, over a network, such as network 220. As aforementioned, a user may include an organization or organizational customer, such as a company, a business, etc., that is a customer to a provider (e.g., Salesforce.com®) that facilitates and/or provides access to cache mechanism 110 (such as via client computer 230). Similarly, a user may further include an individual or a small business, etc., that is a customer of the organization/organizational customer and accesses resource mechanism 110 via another client computing device. Client computing device 290 may be the same as or similar to computing device 100 of FIG. 1 and include a mobile computing device (e.g., smartphones, tablet computers, laptops, etc.) or larger computers (e.g., desktop computers, server computers, etc.).

In one embodiment, reception logic 202 may receive a request from a user (e.g., a customer) for certain information. For example, a representative of Pepsi® submits a data query request to know, for example, how many cans of Pepsi were sold in New York City in January of 2013. The request may be placed by the user via a user interface provided by a software application using a client computing device over a network, such as user interface 234 provided by software application 232 (e.g., websites, software program, social and/or business networking products, such as Chatter® by Salesforce.com, Facebook®, LinkedIn®, etc.) using client computing device 230 over network 220 (e.g., a cloud-based network, the Internet, etc.). Once the request is received at reception logic 202, it is then evaluated for its content by evaluation logic 204. For example, evaluation logic 204 may evaluate the request to determine what type of information is being requested by the user, whether it requires any type of calculation, where it may be stored, whether the same or a similar request been made previously made, etc.

Upon performance of evaluation of the request, in one embodiment, cache generation logic 206 request a dynamic cache 254 may be generated to perform certain data processing so that it can be performed locally as opposed to being performed remotely at data processing server 240 (e.g., Apache® HBase™, etc.), reducing the conventional role of data processing server 240 and providing increased flexibility and scalability. In one embodiment, cache request module 208 of cache generation logic 206, upon receiving evaluation results from evaluation module 204, request multi-tenant database 250 to generate dynamic cache 254 to perform various tasks (e.g., calculations, data processing, etc.) relating to various received and evaluated user requests.

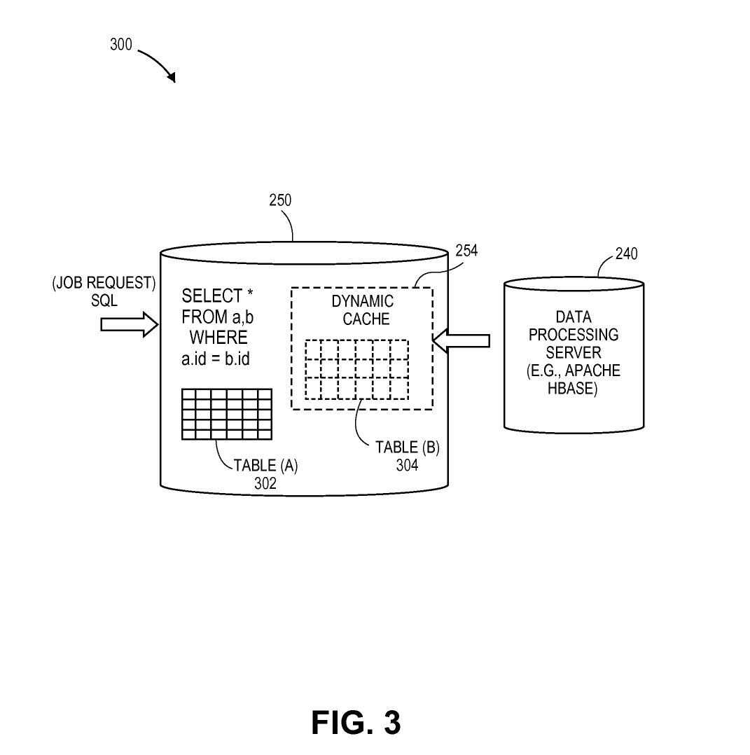

In one embodiment, dynamic cache 254 may serve as a local processing location, at database 250, for the multi-tiered on-demand system, such as for external/remotely-located data processing server 240. In one embodiment, dynamic cache 254 allows for better scalability and more efficiency by providing the processing location at local multi-tenant database 250 such that any tasks (e.g., job requests) may be locally-processed at database 250, via dynamic cache 254, without having to rely on remotely-located, inflexible, and resource-consuming data processing server 240. Dynamic cache 254 may further serve as a virtual connection between a backend server or database, such as data processing server 240 which is used to perform heavy data processing and contains certain general/global information (e.g., formulae, research information, and real-time changing data, etc., relating to various customers), and database 250 that contains other pieces of specific information relating to the requested task and/or the requesting customer (e.g., customer name, customer identification (“id”, “Id” or “ID”), customer's product/services/clients information, customer address and other contact information, etc.). As illustrated in and further described with reference to FIG. 3, dynamic cache 254 may host or directly represent one or more tables, such as table B 304, having data/information provided by data processing server 240, whereas table A 302 may provide information/data held locally by database 250 to process various tasks relating to user requests.

In one embodiment, dynamic cache 254 may contain attributes such as a timestamp, a customerID, a list of key/value pairs, etc. Once dynamic cache 254 has been generated, it is populated with one or more tables having relevant information as facilitated by table module 210. For example, once dynamic cache 254 has been requested and generated, table module 210 facilitates data storage and processing logic 242 at data processing server 240 to populate the one or more tables at dynamic cache 254. In one embodiment, prior to or during processing of the request, if certain entries are needed by not found in the table of dynamic cache 254, an interface to data processing server 240 may be used to obtain the necessary data entries from data processing server 240 and once obtained, the table is populated with the data entries so they may be used in processing of the request. In one embodiment, dynamic cache 254 may be generated or created on-demand in response to a request by cache request module 208. In another embodiment, dynamic cache 254 may be generated or created dynamically or automatically using, for example, user history, account history, type of request, etc. In another embodiment, dynamic cache 254 is maintained by a background process that relies on the expiration setting to perform update on the data. In yet another embodiment, dynamic cache 254 may use optimization technique, such as bulk loading, no logging, indexing, etc.

For example and in one embodiment, history tracker 212 may track and maintain history relating to the user/customer (e.g. a company, organization, business, etc.), their use of the account (e.g., the type of information the customer retrieves, updates, deletes, etc., on a usual basis, such as adding new salespeople every November to handle the anticipated holiday shopping, etc.), their history of request typically placed by them (such as, using our previous example, if Pepsi places the same request every 5^{th} day of the month, etc.), and the like. This history or historical data may be obtained, by history tracker 212, from internal/external logs maintained by various entities, such as the provider (e.g., Salesforce.com). Using this historical information, prediction and expiration module 214 may automatically place a prediction for dynamic cache 254 which may then be used as a dynamic request to generate dynamic cache 254. For example, upon reaching 9 am of the 5^{th} of each month, prediction and expiration module 214 may automatically predict cache 254 in anticipation of the monthly request placed by Pepsi.

As with the on-demand and automatic/dynamic generation of dynamic cache 254, dynamic cache 254 may be ended or forced to expire on-demand and/or automatically/dynamically as facilitated by prediction and expiration module 214. For example, dynamic cache 254 may be granted a fixed amount of time and upon reaching it, dynamic cache 254 may automatically come to an end or end immediately upon completing the tasks or it may be predictively set to end as it may be predictively set to be created and made to process data, etc. In one embodiment, prediction and expiration module 214 may assigned a maximum amount of time to dynamic cache 254 and upon reaching the maximum time, dynamic cache 254 may automatically expire. This maximum amount of time may be assigned based on history (e.g., historical activities) of the organization, nature of the request placed by the user, or it may simply be a default amount of time, etc. Similarly, a minimum amount of time may also be assigned to dynamic cache 254 by prediction and expiration module 214.

Upon generation of dynamic cache 254, whether it be on-demand and/or automatically or dynamically, request issuance and processing logic 216 advises dynamic cache 254 to work with database 250 to obtain any necessary information to process user requests. For example, as illustrated in FIG. 3, table B 304 of dynamic cache 254 may access any number of local tables, such as table A 302 for any relevant information to process user requests. In one embodiment, request issuance and processing logic 216 may trigger or facilitate data storage and processing logic 242 at data processing server 240 to begin processing the user request. In one embodiment, user requests are processed completely and locally at dynamic cache 254 (as they would have been processed at data processing server 240) and by moving the request processing from the backend data processing server, like data processing server 240, to a local cache, such as dynamic cache 254, a high level of intelligence, flexibility, and scalability is introduced that significantly reduces inefficiencies, costs, and resources that are typically associated with reliance on data processing server 240.

Continuing with our previous example, database 250 may provide customer information, such as user ID, object type, object ID, access level, etc., to initiate contact with cache 254 to facilitate it to begin processing the user request. User ID, for example, may indicate the user/customer is Pepsi and similarly, object type may identify the request being about Pepsi cans (sold in New York City in January, 2013, etc.), access level may refer to the level of access the user may have and whether the user request falls within that access level, etc.

Once the request is processed at dynamic cache 254, results collection and presentation logic 218 collects, receives and/or extracts the results from dynamic cache 254 that are then presented to the user via client computing device 230. For example, the results are presented to communication/compatibility logic 220 with communicates the results to client computing device 230 where the results may be displayed using user interface 234 as provided by software application 232. Upon completing the processing of the user request and providing the results to results collection and presentation logic 218, dynamic cache 254 may end either on-demand or automatically.

It is contemplated that any number and type of components may be added to and/or removed from cache mechanism 110 to facilitate various embodiments including adding, removing, and/or enhancing certain features. For brevity, clarity, and ease of understanding of cache mechanism 110, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

FIG. 3 illustrates an architecture 300 having dynamic cache 254 as facilitated by dynamic cache management mechanism 110 of FIG. 1 according to one embodiment. As previously discussed with reference to FIG. 2, dynamic cache 254 may be locally generated at multi-tenant database 250 and includes or represents table B 304 including a value key table associated with a data processing server, such as data processing server 240. Similarly, multi-tenant database 250 provides table A 302 having a value key table associated with multi-tenant database 250. As illustrated, the two tables A 302 and B 304 may receive a user request (e.g., SQL-based query request) along with certain relevant data (e.g., user ID, object ID, organization data, object type, access level, etc.) to properly and completely process the user request at cache 254 using table B 304 along with other relevant data (e.g., logging index, expiration data, background cleanup information, etc.).

In one embodiment, as aforementioned, prior to or during processing of the request, if certain entries are needed for request processing but are missing from table B 264 of cache 254, an application programming interface may be issued and extended to data processing server 240 and may then be used to obtain the necessary missing data entries directly from data processing server 240. Once the data or data entries are obtained from data processing server 240, these data entries are then entered into table B 264 so they may be used for processing of the request.

It is to be noted that embodiments are not limited to a single dynamic cache 254 and that in some embodiments, any number, type, and size of cache may be generated to be represented as dynamic cache, such as dynamic cache 254, having any number of tables, such as dynamic table B 304, may be generated or represented by dynamic cache 254 to process any number and type of user requests.

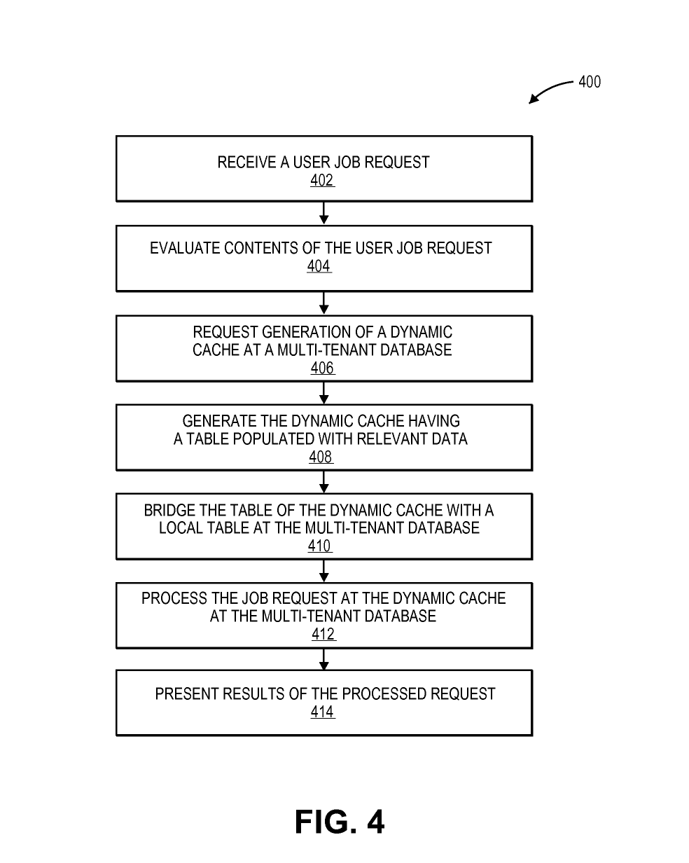

FIG. 4 illustrates a method 400 for facilitating scaling and efficient management of database systems and resources in an on-demand services environment in a multi-tenant environment according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by dynamic cache management mechanism 110 of FIG. 1.

Method 400 begins at block 402 with reception of a user request at cache mechanism 110 of FIG. 1 at a computing device, such as host machine 100 of FIG. 1. The request may have been placed by the user (e.g., a customer or a representative on behalf of the customer) at a client computing device using a user interface provided by a software application (e.g., website, etc.) at the client computing device, such as user interface 234, software application 232, and client computing device 230 of FIG. 2. At block 404, the content of the user request is evaluated for potential processing. At block 406, the result of the evaluation processes are then used to request a dynamic cache to be generated locally at a multi-tenant database associated with the server computer hosting cache mechanism 110 of FIG. 1. Referring back to the Pepsi example, a user associated with Pepsi places the request which is evaluated for processing. Upon evaluation, a dynamic cache is requested to be generated at the local multi-tenant data for processing of the request.

Upon placing the cache-generation request, the dynamic cache is generated at the multi-tenant database and an appropriate table with relevant data is provided through the newly-generated cache at block 408. As aforementioned, in one embodiment, the dynamic cache and any other cache as well as any number and type of tables provided by the cache may be generated on-demand, upon request, or automatically/dynamically, upon prediction based on history. At block 410, in one embodiment, the dynamic cache and the table it represents are communicated with one or more tables at the multi-tenant database. At block 412, the data processing that is typically performed by a remotely-located data processing server is being performed at a locally-situated multi-tenant database using dynamic cache and its table as facilitated by cache mechanism 110 of FIG. 1. At block 414, results from the processing of the request are gathered and presented to be sent to the user. Continuing with the Pepsi example, any basic data relating to the customer (e.g., customer name, customer ID, etc.) or the request (frequency of this particular request, other similar requests by Pepsi, etc.) may be provided by the local multi-tenant database and presented in a table at the local database, while any actual research-related data, such total soda cans/bottles sold in NYC, Coke cans sold in NYC, cans sold at grocery stores, sidewalks, etc., and the like, is provided by the remotely-located data processing server and presented as another table at the dynamic cache at the local database. Both sets of data are put together to process the user request at the dynamic cache to form the results to be presented to the user. At block 416, the results are presented in a particular format (e.g., as requested by the user, such as in a spreadsheets, graphs, charts, text formats, etc.) and provided to the user via a display device or a user interface of a client computing device.

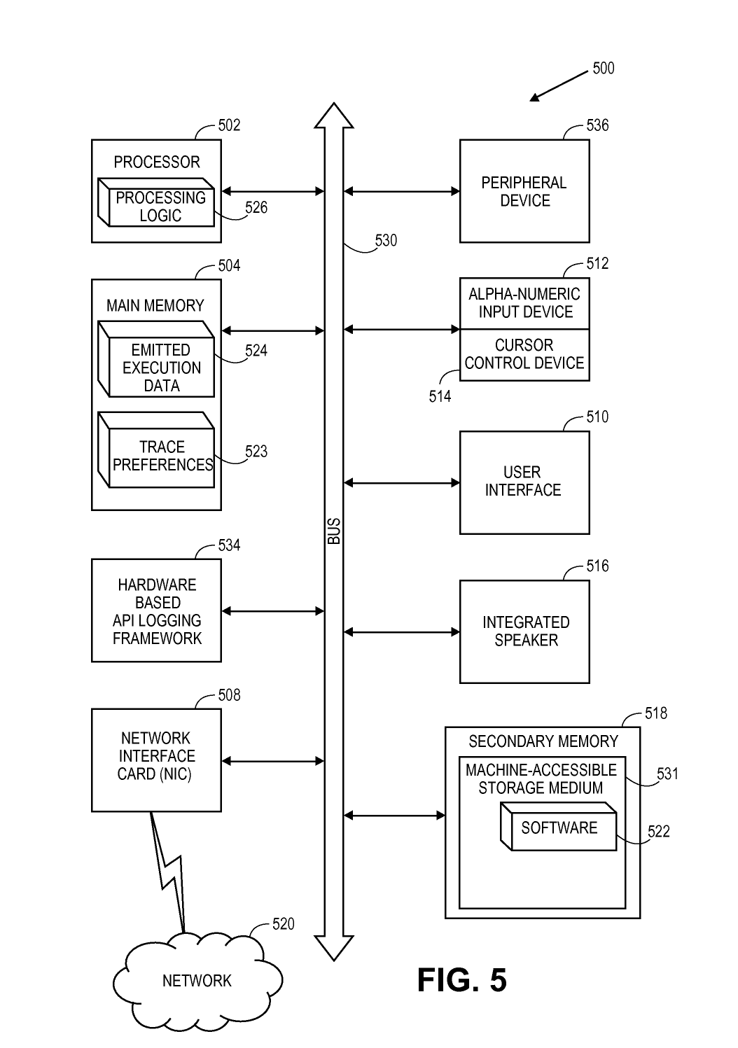

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing device 100 and computing device 230 of FIG. 1 and FIG. 2, respectively. In alternative embodiments, the machine may be connected (e.g., networked) to other machines in a network (such as host machine 100 of FIG. 1 connected with client machine 230 over network 220 of FIG. 2), such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of thread resource management mechanism 110 as described with reference to FIG. 1 and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of thread resource management mechanism 110 as described with reference to FIG. 1 and other figures described herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

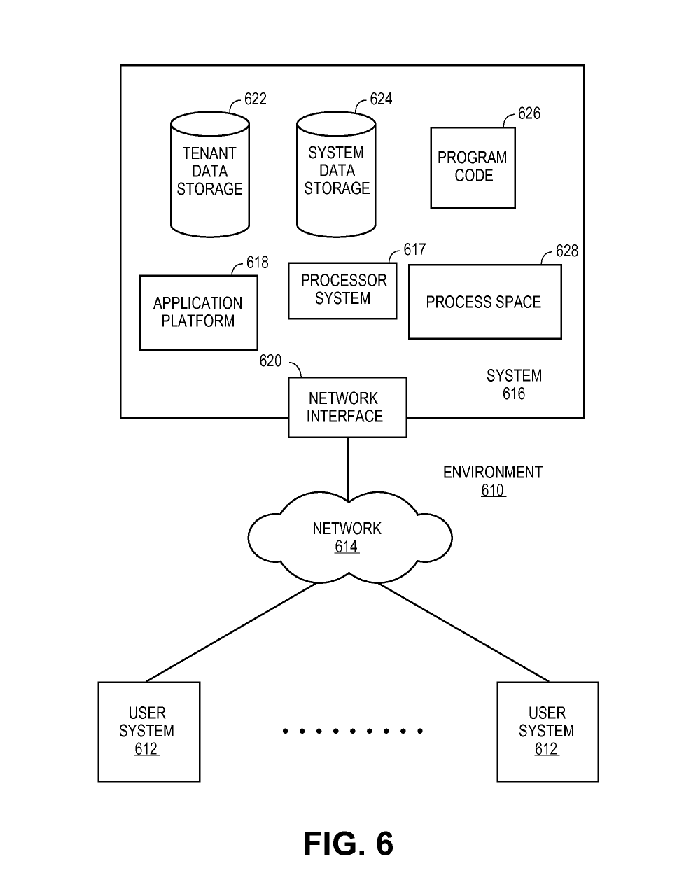

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

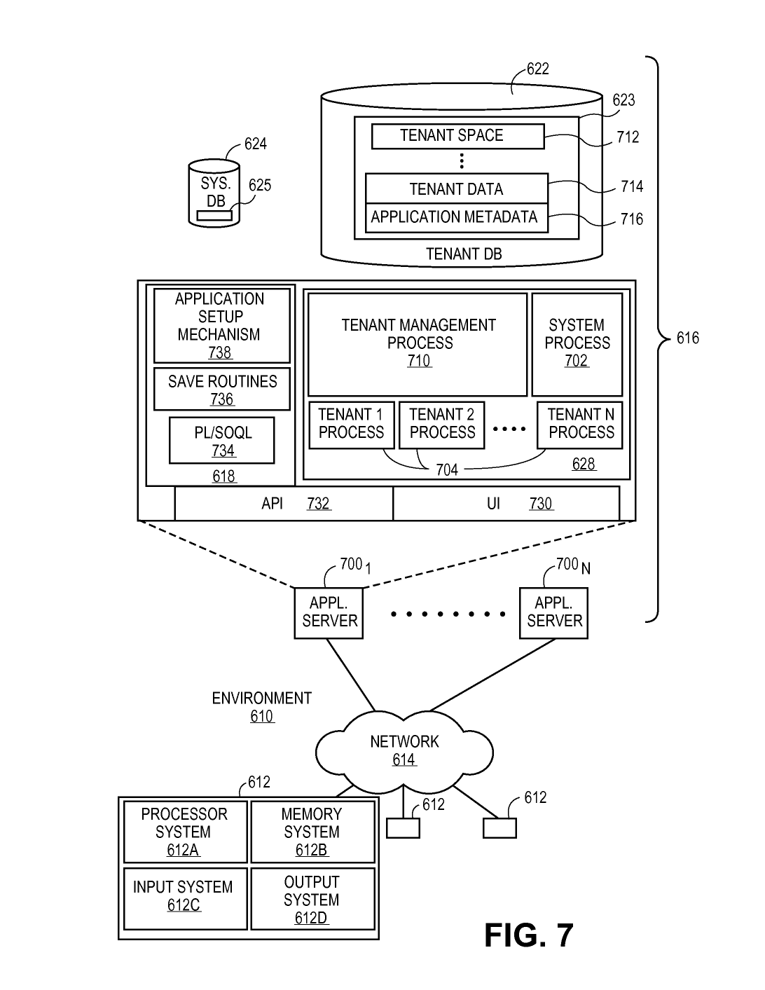

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Core® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
receiving a job request from a user associated with an organization, wherein the job request is placed at a computing device;
generating, at the local database coupled with the computing device, a dynamic cache having a first table comprising external data from an external data source;
communicating the first table of the dynamic cache with a second table at the local database, wherein the second table comprises local data from the local database; and
processing the job request at the local database using the dynamic cache.

2. The method of claim 1, further comprising providing results of the processed job request to the user via the computing device.

3. The method of claim 1, wherein the first table comprises general data relating to the job request or the organization, the general data having one or more of organization name, organization identification, organization address, frequency at which the job request is placed by the organization, and a list of similar job requests placed by the organization.

4. The method of claim 1, wherein the second table comprises specific data relating to the job request and the organization, the specific data having actual research data requested in the job request, wherein the specific data is used with the general data to process the job request at the dynamic cache.

5. The method of claim 1, further comprising:
evaluating contents of the job request; and
requesting generation of the dynamic cache based on the evaluation of the contents of the job request.

6. The method of claim 1, further comprising:
tracking history relating to the organization, wherein the history includes the organization's past activities including past job requests;
predicting generation of the dynamic cache based on the tracked history; and
automatically generating the dynamic cache based on the prediction.

7. The method of claim 1, wherein the job request is placed by the user via a user interface provided by a software application at the computing device, the software application comprising one or more of a business software application, a business networking website, and a social networking website, wherein the computing device includes a client computing device coupled with a server computing device over the network.

8. A system comprising:
a computing device having a memory to store instructions, and a processing device to execute the instructions, the computing device further having a mechanism configured to:
receive a job request from a user associated with an organization, wherein the job request is placed at a computing device;
generate, at the local database coupled with the computing device, a dynamic cache having a first table comprising external data from an external data source;
communicate the first table of the dynamic cache with a second table at the local database, wherein the second table comprises local data from the local database; and
process the job request at the local database using the dynamic cache.

9. The system of claim 8, wherein the mechanism is further configured to provide results of the processed job request to the user via the computing device.

10. The system of claim 8, wherein the first table comprises general data relating to the job request or the organization, the general data having one or more of organization name, organization identification, organization address, frequency at which the job request is placed by the organization, and a list of similar job requests placed by the organization.

11. The system of claim 8, wherein the second table comprises specific data relating to the job request and the organization, the specific data having actual research data requested in the job request, wherein the specific data is used with the general data to process the job request at the dynamic cache.

12. The system of claim 8, wherein the mechanism is further configured to:
evaluate contents of the job request; and
request generation of the dynamic cache based on the evaluation of the contents of the job request.

13. The system of claim 8, wherein the mechanism is further configured to:
track history relating to the organization, wherein the history includes the organization's past activities including past job requests;
predict generation of the dynamic cache based on the tracked history; and
automatically generate the dynamic cache based on the prediction.

14. The system of claim 8, wherein the job request is placed by the user via a user interface provided by a software application at the computing device, the software application comprising one or more of a business software application, a business networking website, and a social networking website, wherein the computing device includes a client computing device coupled with a server computing device over the network.

15. A computer-readable medium having stored thereon instructions which, when executed by a processor, cause the processor to:
receive a job request from a user associated with an organization, wherein the job request is placed at a computing device;
generate, at the local database coupled with the computing device, a dynamic cache having a first table comprising external data from an external data source;
communicate the first table of the dynamic cache with a second table at the local database, wherein the second table comprises local data from the local database; and
process the job request at the local database using the dynamic cache.

16. The computer-readable medium of claim 15, wherein the processor is further to provide results of the processed job request to the user via the computing device.

17. The computer-readable medium of claim 15, wherein the first table comprises general data relating to the job request or the organization, the general data having one or more of organization name, organization identification, organization address, frequency at which the job request is placed by the organization, and a list of similar job requests placed by the organization.

18. The computer-readable medium of claim 15, wherein the second table comprises specific data relating to the job request and the organization, the specific data having actual research data requested in the job request, wherein the specific data is used with the general data to process the job request at the dynamic cache.

19. The computer-readable medium of claim 15, wherein the processor is further caused to:
evaluate contents of the job request; and
request generation of the dynamic cache based on the evaluation of the contents of the job request.

20. The computer-readable medium of claim 15, wherein the processor is further caused to:
track history relating to the organization, wherein the history includes the organization's past activities including past job requests;
predict generation of the dynamic cache based on the tracked history; and
automatically generate the dynamic cache based on the prediction.
